(19) United States
(12) Patent Application Publication
(10) Pub. No.: US 2005/0221167 A1
(43) Pub. Date: Oct. 6, 2005

(54) Electronic equipment

(75) Inventors: Isao Fushimi, Shizuoka (JP); Eiji Matsuyama, Shizuoka (JP)

Correspondence Address: SUGHRUE MION, PLLC, 2100 PENNSYLVANIA AVENUE, N.W., SUITE 800, WASHINGTON, DC, 20037, US

(73) Assignee: STAR MICRONICS CO., LTD.

(21) Appl. No.: 11/092,622

(22) Filed: Mar. 30, 2005

(30) Foreign Application Priority Data
Mar. 30, 2004 (JP) P2004-100130

(51) Int. Cl. H01M 2/10; H04R 25/00

(52) U.S. Cl. 429/96; 381/323; 429/121

(57) ABSTRACT

An electronic device is configured so that a top housing, in which a receiver is incorporated, and a bottom housing, in which a microphone is incorporated, are connected by a positive terminal to each other, and that the housings support each other through the positive terminal. A circuit board is disposed on the positive terminal. The receiver is incorporated into the top housing. The microphone is incorporated into the bottom housing. These housings are connected by the positive terminal. The incorporation of components and the wiring there among can be facilitated.

### BACKGROUND OF THE INVENTION

1. Field of the Invention

The present invention relates to an electronic device, such as a hearing aid, having an internal battery, and, more particularly, to an electronic device having two or more separate housings, into each of which a component is incorporated, and also has a structure in which these housings are connected to one another.

2. Description of the Related Art

For example, there has been known a small hearing aid of a type to be equipped in an ear, which has an ear piece portion to be inserted in the ear provided at an end of a housing accommodating a microphone, a receiver, an amplification circuit, and so on, and also has a battery accommodation cover for accommodating a battery is provided on the rear end surface of the housing, which is exposed when equipped in the ear, along with sound collecting holes for taking in sounds and a volume knob for controlling a sound volume (see, for example, JP-UM-B-7-49920 and JP-B-8-22116). The battery accommodation cover is openably hinge-connected to the rear end surface of the housing. In a state where the battery accommodation cover is opened, the inside of the tray-like battery accommodation cover is exposed. Then, a battery is dropped into the battery accommodation cover. Usually, a small-sized battery of the button type is used.

### SUMMARY OF THE INVENTION

In most of the hearing aids of the structure, the housing is formed with a resin. The resin housing is liable to be damaged by external impact. Thus, it has been considered that the thickness thereof is increased so as to enhance the strength. However, this results in increase of the size of the housing or decrease the internal capacity of the housing. The housing is inserted into an ear and thus naturally limited in size. Further, as described above, a microphone, a receiver, an amplification circuit, and so forth are accommodated in the housing. Thus, there is limitation on an increase in the thickness for enhancing the strength.

Furthermore, the housing is frequently tapered off toward an end portion at the side thereof, which is inserted into an ear. Thus, it is not easy to incorporate components into the housing. Especially, a receiver to be disposed at the end of the housing is difficult to be incorporated. It is considered for facilitating the incorporation of the components that the housing is divided into sub-housings, that then, the components are incorporated into the sub-housings, and that subsequently, the sub-housings are connected to the housing. However, eventually, the feasibility of this process is low due to the low strength of the resin housing. Additionally, circuits and wirings are liable to be concentrated on the rear end surface of the housing. This is a factor in requiring high techniques for performing a wiring operation, and in inhibiting easiness of manufacture of a hearing aid.

Accordingly, an object of the invention is to provide an electronic device capable of enhancing the strength thereof and facilitating both the incorporation of components and the wiring thereof so as to achieve the easy manufacture.

According to the invention, there is provided an electronic device includes plural housings into each of which a component is incorporated, a battery holder portion accommodating a battery that serves as a power supply for each of the components, and a terminal member which conducts electricity from the battery accommodated in the battery holder portion to each of the components, and that the plural housings are connected to one another and supported by the terminal member.

According to the invention, the electronic device has a structure in which the necessary components are accommodated in the plural housings and which these housings are connected by the terminal member to one another. Thus, as compared with a case where plural components are incorporated into one housing and where a wiring operation is operated for conducting the components, the incorporation of components and the wiring operation can significantly be facilitated by dividing the components among the housings and wiring the components through the utilization of the terminal member. Further, the housings are connected to one another and supported by the metallic terminal member. Thus, the strength can be enhanced.

The invention include a mode, wherein the terminal member includes a positive terminal and a negative terminal, and wherein the housings are connected to one another by at least one of these terminals, and also include a mode, wherein the terminal member includes a positive terminal and a negative terminal, wherein the housings are connected to one another by each of the terminals, and wherein each part of the positive terminal and the negative terminal, which connect the housings to each other, is disposed in parallel with each other.

According to the invention, an electronic device has a structure in which plural housings each having a built-in component are connected to one another by a terminal member and support each other. Thus, the strength thereof can be enhanced and the incorporation of the component in the housing and the wiring thereof are facilitated. Consequently, the invention has an advantage in that the easy manufacture of the electronic device is enabled.

### BRIEF DESCRIPTION OF THE DRAWING

These and other objects and advantages of this invention will become more fully apparent from the following detailed description taken with the accompanying drawings in which:

FIGS. 1A and 1B illustrate a hearing aid according to an embodiment of the invention; FIG. 1A is a side cross-sectional view illustrating a state in which a cover is closed; and FIG. 1B is a cross-sectional view taken along line 1B-1B of FIG. 1A;

FIGS. 2A and 2B illustrate the hearing aid according to the embodiment of the invention; FIG. 2A is a side cross-sectional view illustrating a state in which the cover is opened; and FIG. 2B is a rear view illustrating the hearing aid;

FIGS. 3A and 3B are views illustrating an operation of a knob; FIG. 3A is a rear view illustrating a state in which the lock of the cover is released; and FIG. 3B is a view illustrating the positions of contact portions of a volume control brush and a power supply brush provided on the side of a knob with respect to a substrate having a volume control circuit and a power supply circuit;

FIG. 4A is a rear view illustrating the hearing aid in a state where the knob is rotated by 45° clockwise from the state shown in FIGS. 3A and 3B; and FIG. 4B is a view illustrating the positions of the contact portions with respect to the substrate in the state in which the knob is rotated by 45° clockwise from the state shown in FIGS. 3A and 3B;

FIG. 5A is a rear view illustrating the hearing aid in a state where the knob is rotated by 45° clockwise from the state shown in FIGS. 4A and 4B; and FIG. 5B is a view illustrating the positions of the contact portions with respect to the substrate in the state in which the knob is rotated by 45° clockwise from the state shown in FIGS. 4A and 4B;

FIG. 6A is a rear view illustrating the hearing aid in a state where the knob is rotated by 45° clockwise from the state shown in FIGS. 5A and 5B; and FIG. 6B is a view illustrating the positions of the contact portions with respect to the substrate in the state in which the knob is rotated by 45° clockwise from the state shown in FIGS. 5A and 5B;

FIGS. 7A and 7B illustrate a hearing aid according to another embodiment of the invention; FIG. 7A is a side cross-sectional view illustrating a state in which a cover is closed; and FIG. 7B is a cross-sectional view taken along arrows 7B to 7B in FIG. 7A; and

FIGS. 8A and 8B illustrate the hearing aid according to this embodiment of the invention; FIG. 8A is aside cross-sectional view illustrating the state in which the cover is opened; and FIG. 8B is a rear view illustrating the hearing aid.

### DETAILED DESCRIPTION OF THE PREFERRED EMBODIMENTS

Hereinafter, an embodiment in which the invention is applied to a hearing aid will be described by referring to the accompanying drawings.

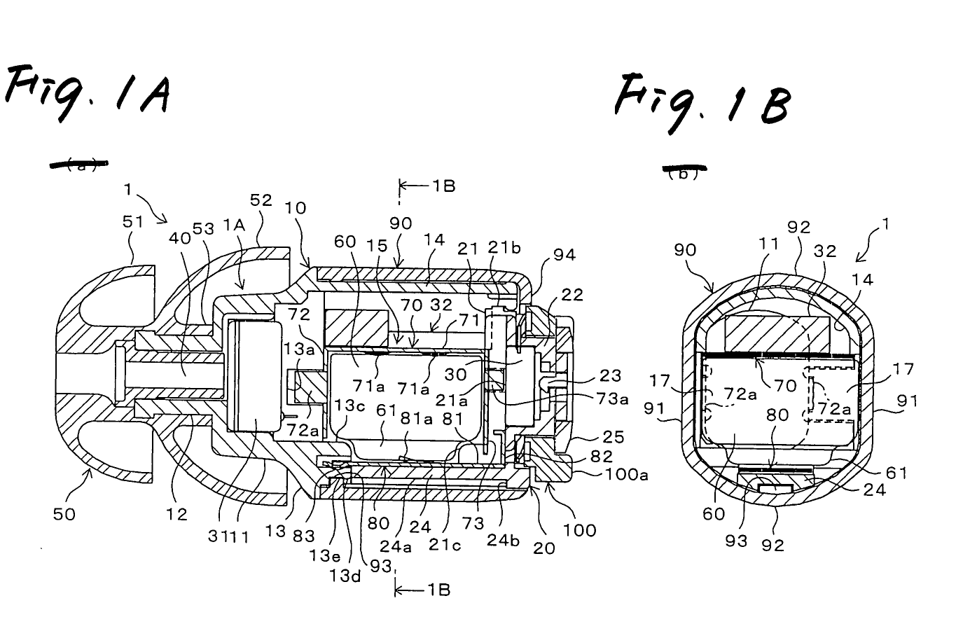

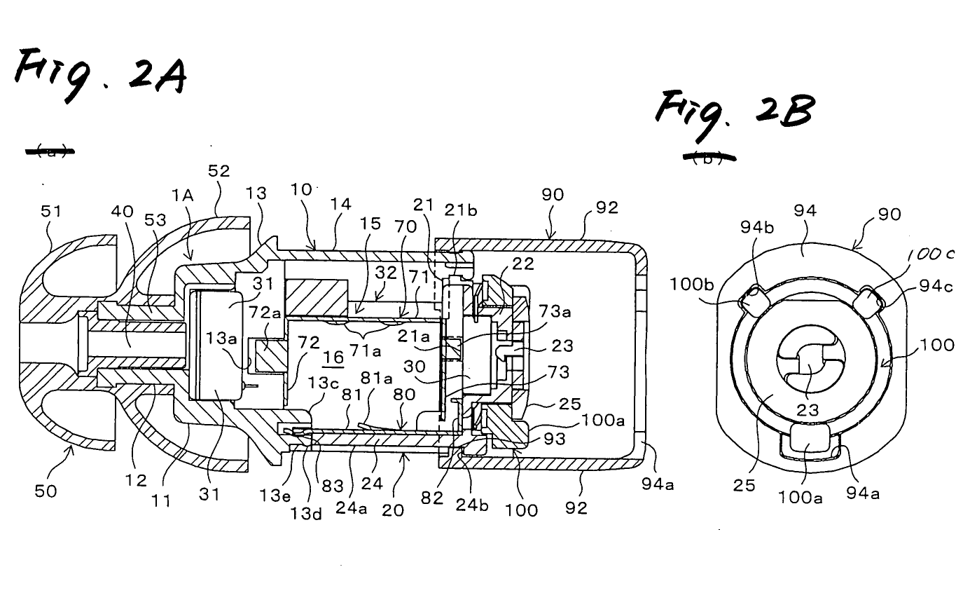

FIGS. 1A, 1B, 2A and 2B illustrate a hearing aid 1 according to the embodiment. The hearing aid 1 is a small-sized one of a type to be equipped in an ear. Reference numeral 1A designates a housing. The housing 1A is a combination of a top housing 10 disposed at the front side thereof, which is the left side viewed in FIG. 1A, and a bottom housing 20 disposed at the rear side of the top housing 10.

The top housing 10 has a cylindrical portion 11 at the front side thereof. A thin cylindrical portion 12 is formed at the center of a front end of the cylindrical portion 11. The cylindrical portion 11 is cross-sectionally longitudinally-elongated and elliptically-shaped as shown in Figs. A tapered portion 13 broaden toward the rear end is formed at the rear end of the cylindrical portion 11. Further, a peripheral wall portion 14 backwardly extended from the peripheral wall of the cylindrical portion 11 is formed in a part (an upper part shown in the figure) of the rear end of the tapered portion 13.

A receiver 31 is fitted into the inside of the cylindrical portion 11 of the top housing 10. The receiver 31 is an electromagnetic receiver of a balanced armature type that has a sound emitting hole at an end surface thereof. A sound passage tube 40 is fixed to the thin cylindrical portion 12 at an end of the top housing 10 by being press-fitted thereinto. An end portion of the sound passage tube 40 is projected from the thin cylindrical portion 12. An ear tip 50 is attached to a part extending the thin cylindrical portion 12 from the projected portion of the sound passage tube 40. The ear tip 50 is formed of a soft material, for example, silicone rubber. A first flange portion 51 and a second flange portion 52, whose diameter is larger than that of the first flange portion 51, are formed around a cylindrical portion 53 in this order from the front side. Both of the flange portions 51 and 52 are gradually broaden from the front side to the rear side like an open umbrella. Both of the portions 51 and 52 are very flexible and elastically deformed. The ear tip 50 is attached to the top housing 10 by press-fitting the thin cylindrical portion 12 into the cylindrical portion 53.

The bottom housing 20 has a bottom plate portion 21 blocking up the rear end of the top housing 10. A peripheral wall portion 24 extending frontward is formed along a part (a lower part, as viewed in the figure) of the peripheral edge of the bottom plate portion 21. The peripheral wall portion 14 of the top housing 10 and the peripheral wall portion 24 of the bottom housing 20 are in an incorporated state illustrated in the figure and opposed to each other in a state where those peripheral wall portions are parallel to each other.

The bottom plate portion 21 of the bottom housing 20 has a cylindrical shaft portion 22, which projects rearward and is provided on the rear end surface thereof. A microphone 30, whose sound collecting portion side is directed rearward, is fitted into the inside of the bottom plate portion 21. A sound collecting hole 23 is formed in the center of the cylindrical shaft portion 22. Moreover, an annular knob 100 is provided on the outer periphery of the cylindrical shaft portion 22 in such a way as to be rotatable around the shaft thereof. The knob 100 is prevented from dropping off by an annular stopper 25, which is fixedly provided on the rear end surface of the cylindrical shaft portion 22. As shown in FIG. 2B, plural projections 100a to 100c protruding radially and rearward are formed at predetermined positions on the outer periphery of the knob 100. In this case, the projections are a first projection 100a, a second projection 100b and a third projection 100c. These projections 100a, 1b and 100c are handholds for facilitating turn of the knob 100 and disposed at positions respectively associated with the vertices of an isosceles triangle, with the first projection 100a at the apex. Incidentally, the second projection 100b and the third projection 100c are equal to each other in size. The first projection 100a is formed larger than the projections 100b and 100c.

The top housing 10 and the bottom housing 20 configure the housing 10 in the arrangement relation in which the peripheral wall portions 14 and 24 are opposed to each other, and are connected through a positive terminal 70 made of an elastic metal. As shown in FIG. 1A, the positive terminal 70 has a top plate portion 71 and also has a front plate portion 72 and a rear plate portion 73, which are suspended vertically from both end edges of the top plate portion 71, respectively, and is formed into a gate shape in side view. Rectangular claw portions 72a extending frontward are formed along one (a near side one, as viewed in FIG. 1A, and a left-side one, as viewed in FIG. 1B) of edge sides of the front plate portion 72 and on a portion on an inner side located within a predetermined distance from the opposite side edge, respectively. Also, rectangular claw portions 73a extending rearward are formed on both side edges of the rear plate portion 73, respectively. That is, the positive terminal 70 has a pair of left-side and right-side claw portions 72a (respectively positioned at a far side and a near side in the drawing of FIG. 1A) provided at a front portion thereof and also has a pair of left-side and right-side claw portions 73a provided at a rear portion thereof.

The pair of the claw portions 72a provided at the front side of the positive terminal 70 are fitted into a shallow concave portion 13a formed in the inner peripheral wall of the tapered portion 13 and fixed thereto by adhesive bonding. The pair of the claw portions 73a provided at the rear side thereof are fitted into a shallow concave portion 21a, which is formed in the inner peripheral surface of the peripheral annular portion 21b formed at the peripheral edge of the bottom plate portion 21 of the bottom housing 20, and fixed thereto by adhesive bonding. Thus, the positive terminal 70 is fixed to the top housing 10 and the bottom housing 20. Consequently, both the housings 10 and 20 are connected to each other through the positive terminal 70. Incidentally, the positive terminal 70 is also fixed to both side edges of the peripheral wall portion 14 of the top housing 10. A circuit board 32 having an IC is fixed to the outer side of the top plate portion 71 of the positive terminal 70 by adhesive bonding. That is, the circuit board 32 is disposed in a space provided between the top plate portion 71 of the positive terminal 70 and the peripheral wall portion 14 of the top housing 10.

Further, a negative terminal 80 configured with an elastic metal piece is fixed to the inner surface of the peripheral wall portion 24 of the bottom housing 20. The negative terminal 80 has a main plate portion 81 opposed to the top plate portion 71 of the positive terminal 70 in parallel, and also has a rear plate portion 82 bending upwardly from and perpendicularly to the rear end of the main plate portion 81, and a terminal portion 83 frontward projecting from the front end of the main plate portion 81. The negative terminal 80 is fixed to the bottom housing 20 by adhesive-bonding the main plate portion 81 to the inner surface of the peripheral wall portion 24 and also adhesive-bonding the rear plate portion 82 to the bottom plate portion 21.

In the housing 1A, the battery holder portion 15 is configured with the positive terminal 70 and the negative terminal 80. The internal space thereof is used as a battery accommodation space 16. A battery 60 for supplying electric power to an IC for driving the microphone 30 and the receiver 31 through the circuit board 32 is accommodated in the battery accommodation space 16. The battery 60 is of the thin cylindrical button type and has a negative electrode on an axial end surface of the projection portion 61, and a positive electrode on a part extending from the opposite side end surface of the projection portion 61 to the peripheral surface thereof.

The battery 60 is accommodated in the battery accommodation space 16 in a position in which the projection portion 61 is directed to the negative terminal 80 shown at a lower part of the figure, and in which the bottom surface of the positive electrode is directed to the top plate portion 71 of the positive terminal 70. In such a accommodation state, a contact piece 71a formed in the top plate portion 71 of the positive terminal 70 is put into elastic contact with the bottom surface, that is, the positive electrode of the battery 60, while a contact piece 81a formed in the main plate portion 81 of the negative terminal 80 is put into elastic contact with an end surface, that is, the negative electrode of the projection portion 61. Thus, the battery 60 is held in the battery accommodation space 16.

In the housing 1A, both sides of a part provided between the upper and lower peripheral wall portions 14 and 24 are opened. One of such openings 17 is used as an insertion port through which the battery 60 is inserted into the battery accommodation space 16. The other is used as an ejection port from which the battery 60 is ejected. During the battery 60 is in the aforementioned position in the battery accommodation space 16, the battery 60 is accommodated in the battery accommodation space 16 from one of the openings 17. Also, during the battery 60 is in the same position, the battery 60 is taken out of the other opening 17. Thus, each of these openings 17 is set in such a way as to have a size and a shape, which allow the battery 60 to pass therethrough.

In a lower part of the tapered portion 13 in the inner surface of the top housing 10, as viewed in the figure, a step portion 13c is formed. Further, a pair of step portions 21c are formed on both sides of the rear plate portion 82 of the positive terminal 70 in a part extending the bottom plate portion 21 to the peripheral wall portion 24 in the inner surface of the bottom housing 20. Since these step portions 13c and 21c are formed, the shape (that is, the shape of a cross-section perpendicular to a direction in which the battery 60 is inserted and ejected) of the battery accommodation space 16, which is seen from the opening 17, is similar to the shape in side view of the accommodated battery 60, as shown in FIG. 1A.

A cover 90 is axially slidably mounted on the outer periphery sides of the upper and lower peripheral wall portions 14 and 24 configuring the housing 1A. The axial length of the cover 90 is nearly equal to that of each of the peripheral wall portions 14 and 24. The cover 90 blocks up the openings 17 in a position in which the cover 90 covers the entire outer peripheral surfaces of the wall portions 14 and 24. Additionally, when the cover 90 is slid rightward, as viewed in FIG. 1A, each of the openings 17 opens as shown in FIG. 2A.

As shown in FIG. 1B, the cover 90 is a longitudinally-elongated and cross-sectionally elliptically-shaped cylindrical one having both side wall portions 91 and upper and lower peripheral wall portions 92, which connect these side wall portions 91 to each other, as viewed in the figure. As shown in FIGS. 1A and 1B, the cylindrical portion 11 of the top housing 10 is decentered toward a side with respect to a cylindrical element formed by the cover 90 and the upper and lower peripheral wall portions 14 and 24. A short ridge 93 extending in the circumferential direction is formed on the front inner peripheral surface of the lower peripheral wall portion 92 of the cover 90. Meanwhile, a guide groove 24a extending axially, into which the ridge 93 is fitted, is formed in the outer peripheral surface of the peripheral wall portion 24 of the bottom housing 20. The ridge 93 slides along the guide groove 24a. Consequently, the axial sliding of the cover 90 is guided.

A stopper step portion 24b, against which the ridge 93 abuts, is formed at the rear end of the guide groove 24a in the peripheral wall portion 24 of the bottom housing 20. The ridge 93 abuts against the stopper step portion 24b. Consequently, the cover 90 is prevented from dropping off in a fully open state in which the openings 17 are opened. Moreover, a hook portion 13d slightly projecting toward the outer periphery side and a stopper groove 13e provided at the front side of the hook portion 13d are formed in the outer peripheral surface of the lower rear end portion in the tapered portion 13 of the top housing 10. The ridge 93 runs on the hook portion 13d and fitted into the stopper groove 13e. Consequently, the cover 90 comes to be unable to slide and is held in a fully closed state in which the openings 17 are closed.

Meanwhile, in the hearing aid 1 according to the embodiment, external sounds introduced to the microphone 30 from the sound collecting hole 23 are emitted from the receiver 31. An on/off switch for causing the hearing aid 1 to activate or stop an operation of the hearing aid 1, and the control of the volume of sounds emitted from the receiver 31 are performed by the knob 100. Further, the knob 100 also has the function of holding the closed state of the cover 90 during the operation.

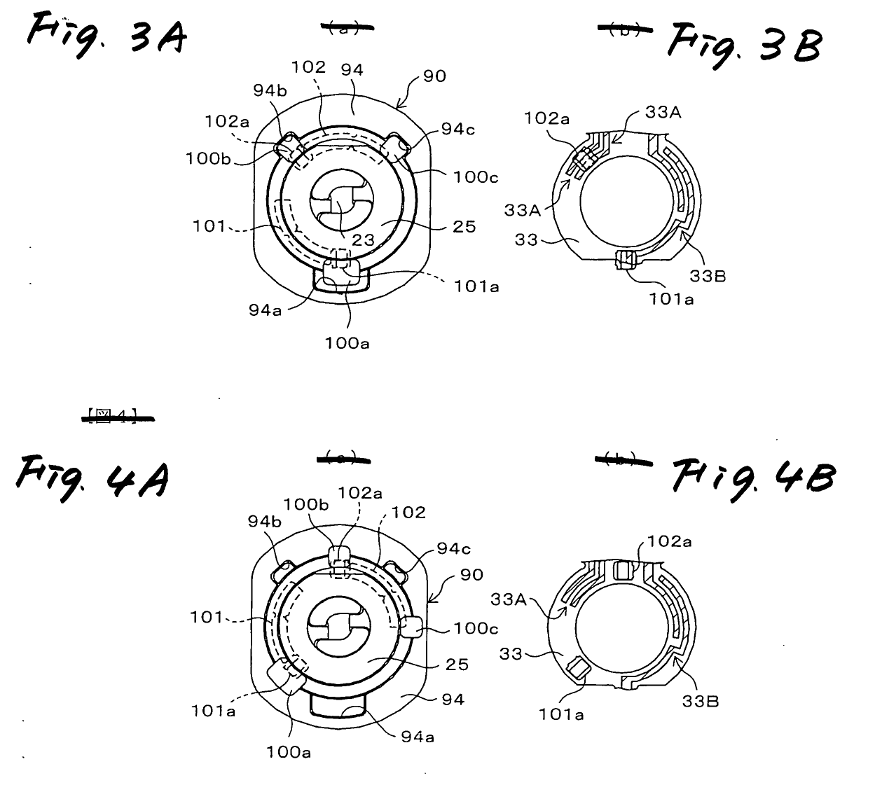

As shown in FIGS. 1A and 3A, the rear end edge of the cover 90 inwardly bends, so that a flange portion 94 is formed. Plural rectangular cutouts 94a to 94c opened in an inner circular hole are formed in the flange portion 94. In this case, the cutouts are a first cutout 94a, a second cutout 94b, and a third cutout 94c formed at positions associated with the projections 100a to 100c in such a manner as to have an associated size. As shown in FIG. 3A, the knob 100 is in a position in which the first projection 100a is positioned in the lowest place in the figure, and in which the second projection 100b and the third projection 100c are at an upper place and arranged in a horizontal line. The knob 100 is brought into a lock releasing state, in which the cover 90 can be opened.

As shown in FIGS. 3A and 3B, a sound volume control brush 101 and a power supply brush 102 are provided at predetermined places on the back surface of the knob 100. Each of the brushes 101 and 102 is provided with an associated one of contact portions 101a and 102a. Meanwhile, an annular substrate 33 is fixed to a part of the bottom plate portion 21 of the bottom housing 20, which faces the back surface of the knob 100. A sound volume control circuit 33A for controlling a sound volume, and a power supply circuit 33B for turning ON/OFF a power supply are formed on the substrate 33. The contact portions 101a and 102a of the brushes 101 and 102 are put into contact with the circuits 33A and 33B according to rotation patterns of the knob 100. Each of the circuits 33A and 33B has two circuits, which are short-circuited by being brought in contact with the contact portions 101a and 102a of the brushes 101 and 102 to thereby perform a predetermined operation, and is connected to the circuit board 32.

Operations of the knob 100 are performed as follows.

(a) Power Supply OFF —Release of Lock of the Cover 90

When the knob 100 is put in the lock releasing position, the projections 100a, 100b and 100c are placed at positions respectively associated with the cutouts 94a, 94b and 94c, as shown in FIG. 3A. Then, the cover 90 is slid in an opening direction, the cutouts 94a to 94c pass through the projections 100a to 100c, respectively, and can slide, so that the cover 90 can be fully opened. As shown in FIG. 3B, the contact portion 102a of the power supply brush 102 is not in contact with the power supply circuit 33B. Thus, the power supply is in an OFF-state.

(b) Power Supply OFF—Cover 90 in Locked State

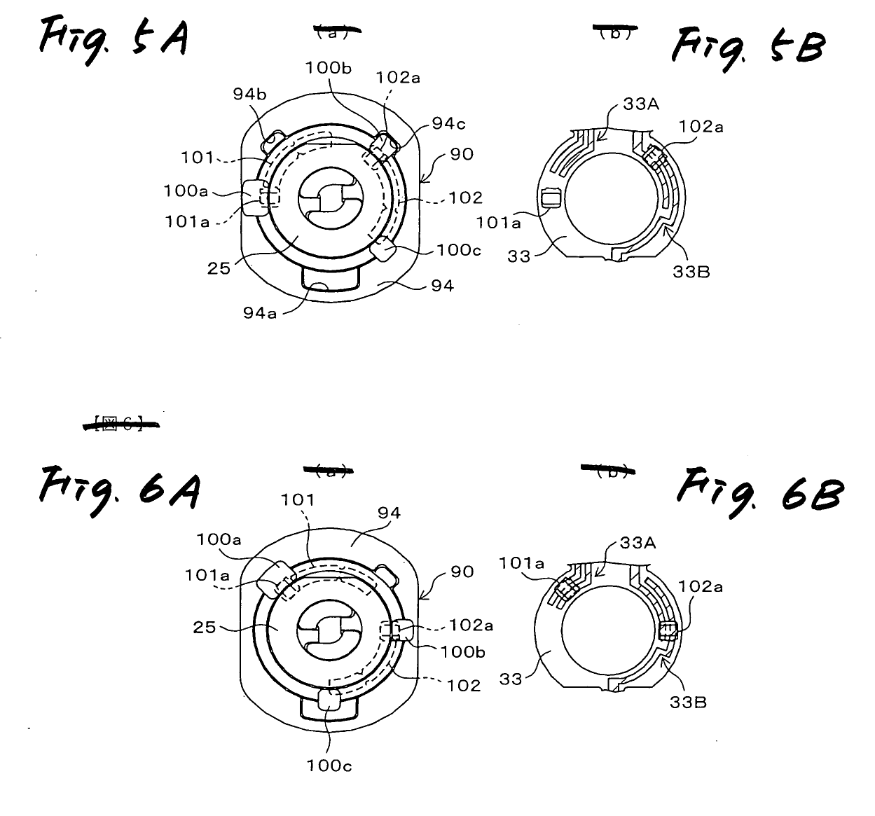

When the knob 100 is turned by 45° clockwise from the lock releasing state, as shown in FIG. 4A, the projections 100a to 100c engage with the flange portion 94 of the cover 90. That is, the flange portion 94 of the cover 90 abuts against the projections 100a to 100c. Consequently, the cover 90 is put into a lock state in which the cover 90 is prevented from dropping off. Therefore, the battery 60 is held. Further, as shown in FIG. 4B, the contact portion 102a of the power supply brush 102 is not in contact with the power supply circuit 33B. Thus, the power supply is in the OFF-state.

(c) Power Supply ON, Sound Volume Low Level—Cover 90 in Locked State

When the knob 100 is turned by 45° clockwise from the state (b), as shown in FIG. 5A, the contact portion 102a of the power supply brush 102 is brought into contact with the power supply circuit 33B. Thus, the power supply is put into an ON-state. Although the power supply is put into an ON-state, the contact portion 101a of the sound volume control brush 101 is not in contact with the sound volume control circuit 33A. Thus, the sound volume is at the lowest level and has the constant level. Further, the flange portion 94 of the cover 90 abuts against the projections 100a to 100c, so that the cover 90 is continuously in the locked state.

(d) Power Supply ON, Sound Volume High Level—Cover 90 in Locked State

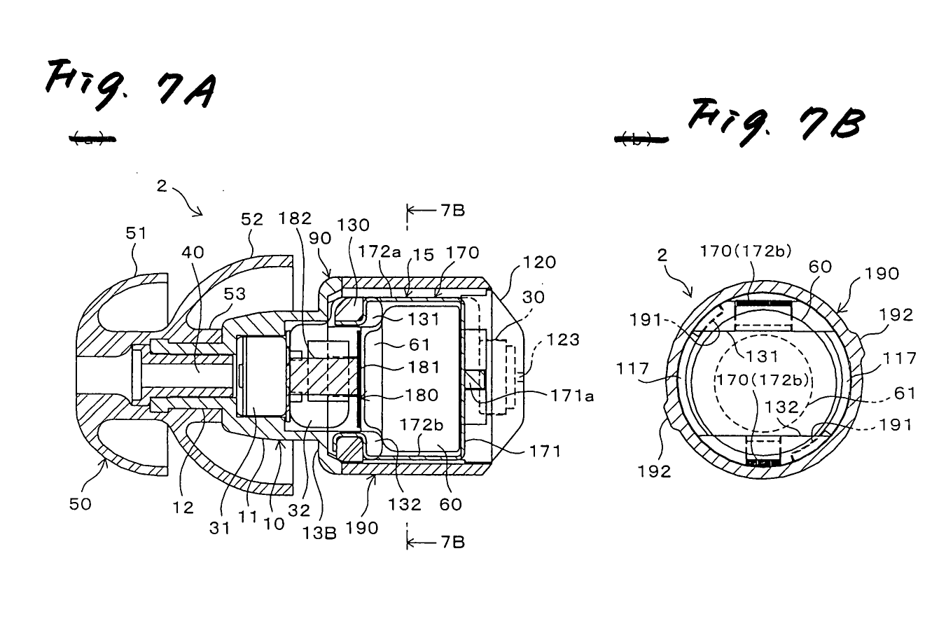

When the knob 100 is turned by 45° clockwise from the state (c), as shown in FIG. 6A, the contact portion 101a of the sound volume control brush 101 is brought into contact with the sound volume control circuit 33A. Thus, the sound volume can be increased to a predetermined level. Incidentally, in a range in which the knob 100 is turned by 45° from the state (c), the contact portion 102a of the power supply brush 102 is brought into contact with the power supply circuit 33B. Thus, the power supply is always in the ON-state. Because the flange portion 94 of the over 90 abuts against the projections 100a to 100c, the cover 90 is continuously in the locked state.

Incidentally, linear sound volume control can be performed by configuring the sound volume control circuit 33A through the use of a resistance wire or the like and by causing the sound volume control circuit 33A to function as a variable resistor.

Next, an operation of the hearing aid 1 according to this embodiment is described hereinbelow.

When the battery 60 is accommodated in the battery accommodation space 16 in the hearing aid 1, electric power is supplied to the IC for driving the microphone 30 and the receiver 31 through the circuit board 32. In a state where the cover 90 is closed and the power supply is put into the OFF-state by the knob 100, the ear tip 50 is inserted into an external ear canal. Then, the power supply is put into the ON-state by the knob 100. Additionally, while the sound volume is controlled, the hearing aid is used. Sounds are collected through the microphone 30 from the sound collecting hole 23. The collected sound is amplified on the circuit board 32 and emitted from the receiver 31. Then, the sounds are emitted from the sound passage tube 40 through an end opening of the ear tip 50 into an outer ear. The sound volume of the emitted sounds can be controlled by rotating the knob 100, as described above.

Next, the procedure for exchanging the accommodated battery 60 is described hereinbelow.

The cover 90 is opened by setting the knob 100 in a lock releasing position. A battery 60 to be newly accommodated is put into the same position as that of the accommodated old battery 60. The new battery 60 is inserted into the battery accommodation space 16 from one of the openings 17.

When the new battery 60 is inserted thereinto, the old battery 60 is simultaneously pushed out by the new battery 60. When the new battery 60 is accommodated in the battery accommodation space 16, the old battery 60 is ejected from the other opening 17 and taken out therefrom. When the new battery 60 is accommodated therein in this way, the cover 90 is slid frontward and closed. Thus, the exchange of the battery 60 is finished.

In such a battery exchange operation, the accommodation of the new battery 60 can be performed simultaneously with the ejection of the old battery 60. Thus, the battery exchange operation can easily and smoothly be performed. This easiness of the exchange operation is very advantageous especially for small electronic devices, such as a hearing aid. Additionally, the new battery 60 is inserted thereinto as watching the old battery 60 accommodated in the battery accommodation space 16. Consequently, the new battery 60 can correctly be accommodated thereinto without making a mistake in the polarity. Especially, in the case of the embodiment, since these step portions 13c and 21c are formed, the battery accommodation space 16 appears to have a shape similar to that of the battery 60. Consequently, the polarity can be more effectively prevented from being mistaken. Also, even when the battery 60 is accommodated in an empty battery accommodating space 16, an erroneous insertion thereof is hardly caused by mistaking the polarity.

The hearing aid 1 according to the embodiment has a structure in which the receiver 31 is accommodated in the top housing 10, and in which the microphone 30 is accommodated in the bottom housing 20, and in which these housings 10 and 20 are connected by the positive terminal 70 to each other. As compared with the conventional case where plural components are incorporated into a single housing, and where a wiring operation is operated for conducting the components, the embodiment significantly facilitates the incorporation of the components and the wiring operation by dividing the components (such as the microphone 30 and the receiver 31) between the top housing 10 and the bottom housing 20 and by wiring the components through the utilization of the positive terminal 70 and the negative terminal 80. Further, the housings 10 and 20 are connected to one another and supported by the metallic positive terminal 70. Thus, the strength can be enhanced.

Further, in the embodiment, since the circuit board 32 is fixed onto the positive terminal 70, the easiness of fabrication is enhanced still more by arranging the circuit board 32 on the positive terminal 70 and subsequently fixing the positive terminal 70 to each of the housings 10 and 20. Furthermore, since the circuit board 32 is disposed in the space between the positive terminal 70 and the top plate portion 71 of the top housing 10, the embodiment has an adequate space for arranging the components, and an operation of wiring the circuit board 32 can be performed in a large working space and in a stable state before the components are incorporated. Additionally, because of the facts that the top plate portion 71 of the positive terminal 70 is fixed in such a way as to be parallel to the peripheral wall portion 14 of the top housing 10 in the embodiment, and that the positive terminal 70 is parallel to the main plate portion 81 of the negative terminal 80 fixed to the peripheral wall portion 24 of the bottom housing 20, the strength of connecting the housings 10 and 20 is enhanced still more.

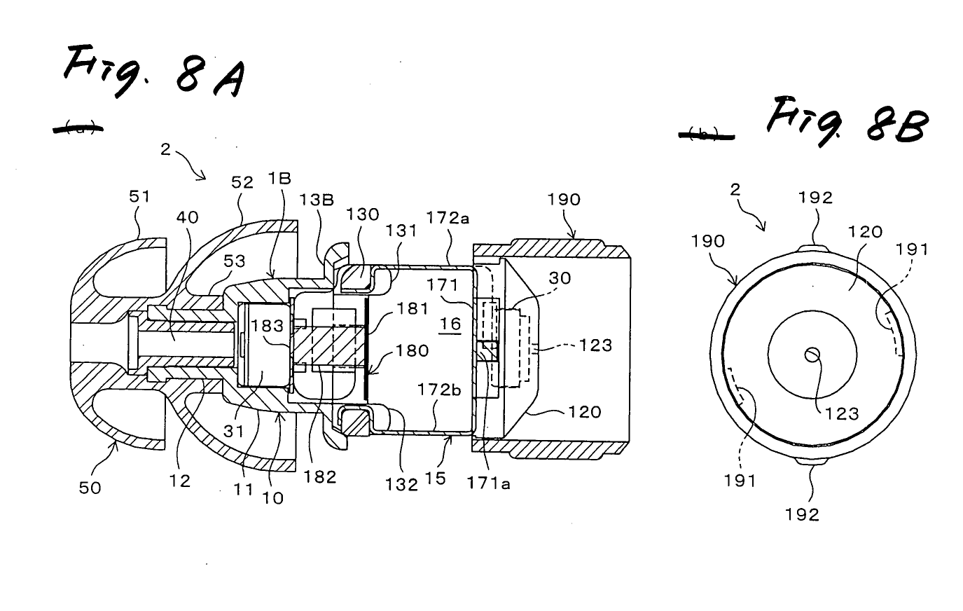

Next, another embodiment of the invention is described by referring to FIGS. 7A, 7B, 8A and 8B.

In these figures, constituent elements, which are the same as those of the embodiment (shown in FIGS. 1A to 6B), are designated by the same reference characters used for denoting the constituent elements of the embodiment. Thus, the description of such constituent elements is omitted or simplified.

A housing 1B of a hearing aid 2 according to another embodiment is configured with a top housing 10 and a bottom housing 120, which are similar to those of the embodiment, and an inner housing 130. Similarly to the embodiment, a receiver 31 is set in the top housing 10. Further, an ear tip 50, which is similar to that of the embodiment, is attached to an end portion of the top housing 10. The rear end portion of the top housing is shaped into a collar portion 13B, instead of the tapered portion.

The inner housing 130 is shaped like a ring, and disposed at a stage subsequent to the collar portion 13B of the top housing 10. The outer peripheral surface of the inner housing 130 is fixed to the inner peripheral surface of the top housing 10. The bottom housing 120 is shaped like a disk and disposed at a stage subsequent to the top housing 10 in such a manner as to be interposed by a battery accommodation space 16 and as to be coaxial therewith. The bottom housing 120 has a built-in microphone 30 in the central part of which a sound collecting hole 123 for guiding external sounds thereto is formed.

The bottom housing 120 and the inner housing 130 are connected to each other by a positive terminal 170. The positive terminal 170 has a disk-like bottom plate portion 171 fixed to the inner surface of the bottom housing 120 and a pair of upper and lower plate portions 172a and 172b extending frontward, as viewed in the figure, from an edge of the bottom plate portion 171. The upper side plate portion, that is, the upper plate portion 172a has an end part that bends along the inner surface of the inner housing 130. This end bending part is fixed to the inner surface of the inner housing 130. Further, the lower side plate portion, that is, the lower plate portion 172b has an end part that bends along the inner surface of the inner housing 130. An end section of the end part bends up to the front surface of the inner housing 130. The end bending part is engaged with the inner housing 130 and fixed thereto. Furthermore, claw portions 171a extending backwardly are formed on the edge of a side portion of the bottom plate portion 171 of the positive terminal 170. These claw portions 171a are fitted into the bottom housing 120 and fixed thereto.

Thus, the positive terminal 170 is fixed to the bottom housing 120 and the inner housing 130. Consequently, the inner housing 130, which is fixed to the top housing 10, and the bottom housing 120 are connected to each other through the positive terminal 170.

A circuit board 32 is disposed in a space that is provided at the rear of the receiver 31 in the top housing 10. A negative terminal 180 is disposed at the rear of the circuit board 32. The negative terminal 180 has a main plate portion 181, which faces the bottom plate portion 171 of the positive terminal 170 in parallel thereto, a pair of left-side and right-side side plate portions 182 extending frontward from the edges of the side parts of the main plate portion 181, and a front plate portion 183 that faces a part extending from an end of one of the side plate portions 182 in parallel with the main plate portion 181. The circuit board 32 is held in a part surrounded by these plate portions 181, 182 and 183. Each of the side plate portions 182 of the negative terminal 180 is fixed to a cylindrical portion 11 of the top housing 10 and the inner surface of the inner housing 130. Consequently, the circuit board 32 and the negative terminal 180 are fixed to the top housing 10.

In the housing 1B, a battery holder portion 15 is configured with the bottom plate portion 171 and the upper and lower plate portions 172a and 172b of the positive terminal 170, and the main plate portion 181 of the negative terminal 180. The inner space thereof is used as the battery accommodation space 16. A battery 60 for supplying electric power to an IC for driving the microphone 30 and the receiver 31 through the circuit board 32 are accommodated in the battery accommodation space 16.

The battery 60 is accommodated in the battery accommodation space 16 by taking a transverse position in which a projection portion 61 is directed to the front ear tip 50, and in which the axial direction thereof is set to be parallel to the housing 1B. In such an accommodation state, the bottom plate portion 171 of the positive terminal 170 is brought into contact with the bottom surface of the battery 60, that is, the positive electrode, while the main plate portion 181 of the negative terminal 180 is brought into contact with an end surface of the projecting portion 61 of the battery 60, that is, the negative electrode.

Openings 117 opened to the battery accommodation space are provided between the upper and lower plate portions 172a and 172b of the positive terminal 170. One of these openings 117 is used as an insertion port through which the battery 60 is inserted into the battery accommodation space 16. The other opening 117 is used as an ejection port through which the battery 60 is taken out therefrom. Step portions 131 and 132 are formed on the rear end surfaces of the inner housing 130, which are also both side portions of the positive terminal 170. The projecting portion 61 of the battery 60 is sandwiched and held between these step portions 131 and 132. Furthermore, because of these step portions 131 and 132, the shape (that is, the shape of a cross-section perpendicular to a direction in which the battery 60 is inserted and ejected) of the battery accommodation space 16, which is seen from the opening 117, is similar to the shape in side view of the accommodated battery 60, as shown in FIG. 8A.

A cylindrical cover 190 extending from the rear end surface of the collar portion 13B of the top housing 10 to the front end surface of the bottom housing 120 is axially slidably mounted on the outer peripheral sides of the upper and lower plate portions 172a and 172b of the positive terminal 170. FIG. 7A shows a fully closed state in which the openings 117 are blocked up by the cover 190. When the cover 190 is slid rightward from the state shown in FIG. 7A, the openings 117 are opened as shown in FIG. 8A. The front end portion of the cover 190 is slidably fitted into the inner housing 130 in a state where the cover 190 is in the fully closed state.

Stoppers 191 configured with thin ridges are formed in the front end inner peripheral surface of the cover 190 at positions spaced apart by 180°. The stoppers 191 are adapted so that when the cover 190 can be opened and closed, one of the stoppers 191 is placed in one of the openings 117 and the other stopper 191 is placed in the other opening 117. Although the cover 190 can be slid in any circumferential direction, the stoppers 191 abut against the upper and lower plate portions 172a and 172b of the positive terminal 170, respectively, to thereby restrain the cover 190 from rotating still more. Further, when the cover 190 is gradually opened, the stoppers 191 abut against the bottom housing 120 to thereby prevent the cover 190 from dropping off. Thus, in such a state, the cover 190 is fully opened.

When the cover 190 is gradually slid from the state, in which the cover 190 is opened (as shown in FIG. 8A), to the front end at the side of the ear tip 50, the end surface of the cover 190 abuts against the rear end surface of the inner housing 130 to thereby bring the cover 190 into the fully closed state. This fully closed state is held by rotating the cover 190 to thereby fit the stoppers 191 into grooves (not shown) formed in the outer peripheral surface of the inner housing 130, so that the cover 190 cannot slide. Incidentally, plural ridges 192 extending axially are formed on the outer peripheral surface of the cover 190 at uniform peripheral intervals circumferentially as slip stoppers.

According to the hearing aid 2 of the embodiment, when a battery 60 is accommodated in the battery accommodation space 16, the positive electrode of the battery 60 is brought into contact with the bottom plate portion 171 of the positive terminal 170, while the negative electrode thereof is put into contact with the main plate portion 181 of the negative terminal 180. Thus, the power supply is turned on. In this state, the hearing aid is used by inserting the ear tip 50 into an external ear canal. Similarly to the embodiment, the exchange of the battery 60 can be performed by opening the cover 190 and inserting a new battery 60 from one of the openings 117 and simultaneously pushing out an old battery 60.

Even in the case of the hearing aid 2 of the embodiment, the positive terminal 170 connects the top housing 10 and the inner housing 130 and also connects the housings 10 and 130 and the divided bottom housing 120 so that these housings support one another. Therefore, the embodiment has advantages, which are similar to those of the embodiment, in that the embodiment significantly facilitates the incorporation of the components and the wiring operation by dividing the components (such as the microphone 30 and the receiver 31) between the top housing 10 and the bottom housing 120 and by wiring the components through the utilization of the positive terminal 170 and the negative terminal 180, that the housings 10 and 120 are connected to one another and supported by the metallic positive terminal 170, and that thus, the strength can be enhanced.

Especially, in the embodiment, the housing is not extended so as to be fixed to the connecting positive terminal 170. Instead, the positive terminal 170 singly connects the housings 10 and 120 to each other. Thus, the miniaturization and the reduction in weight of the hearing aid can be achieved.

Incidentally, the embodiment may be modified as follows. That is, the cover 190 and the bottom housing 120 are integrally formed as a bottom housing, instead of separately providing the cover 190 thereinto. The bottom housing is slid by using the upper and lower plate portions 172a and 172b of the positive terminal 170, thereby to open and close the battery accommodation space 16.

The foregoing description of preferred embodiments of the invention has been presented for purposes of illustration and description. It is not intended to be exhaustive or to limit the invention to the precise form disclosed, and modifications and variations are possible in light of the above teachings or may be acquired from practice of the invention. The embodiments were chosen and described in order to explain the principles of the invention and its practical application to enable one skilled in the art to utilize the invention in various embodiments and with various modifications as are suited to the particular use contemplated. It is intended that the scope of the invention be defined by the claims appended hereto, and their equivalents.

1. An electronic device comprising:
plural housings into each of which a component is incorporated;
a battery holder portion accommodating a battery that serves as a power supply for each of the components; and
a terminal member which conducts electricity from the battery accommodated in the battery holder portion to each of the components, wherein
the plural housings are connected to one another and supported by the terminal member.

2. The electronic device according to claim 1, wherein
the terminal member includes a positive terminal and a negative terminal, and
the housings are connected to one another by at least one of the terminals.

3. The electronic device according to claim 1, wherein
the terminal member includes a positive terminal and a negative terminal,
the housings are connected to one another by at least a part of each of the terminals, and
each part of the positive terminal and the negative terminal, which connects the housings to each other, is disposed in parallel with each other.
